(19) United States
(12) Patent Application Publication
(10) Pub. No.: US 2004/0076929 A1
(43) Pub. Date: Apr. 22, 2004

(54) Training device for motorcycle racing

(76) Inventor: Alan L. Gerkey, Menifee, CA (US)

Correspondence Address: Eric K. Satermo, Registered Patent Agent, P.O. Box 19099, Irvine, CA, 92623-9099, US

(21) Appl. No.: 10/615,334

(22) Filed: Jul. 8, 2003

Related U.S. Application Data
(60) Provisional application No. 60/393,898, filed on Jul. 8, 2002.

(51) Int. Cl. G09B 9/058

(52) U.S. Cl. 434/61

(57) ABSTRACT

A training device for motorcycle racing includes a handlebar including a right-hand grip and a left-hand grip, a control lever mounted to the handlebar at or near the left-hand grip for simulating a clutch of a motorcycle, and a timing circuit. The timing circuit may include a display, a timer, and an output such as a LED for generating a signal when activated. A random-timing generator may be connected to the timer and the output, and a switch may be connected to the timer and the random-timing generator and operatively connected to the control lever. In operation, the switch activates the random-timing generator when the control lever is actuated. In turn, the random-timing generator simultaneously activates the timer to begin timing and activates the output to generate a signal, at a random time after being activated by the switch. The switch then stops the timer when the control lever is released. The display displays an elapsed time between the time when the timer was activated and to the time when the timer was stopped.

### CROSS REFERENCE TO RELATED APPLICATIONS

The present application claims priority on U.S. Provisional Application for Patent Serial No. 60/393,898 filed Jul. 8, 2002, the entire disclosure of which is incorporated herein by reference

### BACKGROUND OF THE INVENTION

The present invention relates to training devices for motorcycle racing.

In many sporting events in which athletes compete against each other, success often depends upon speed. In motorcycle racing, the reaction time of a rider at the start of a race is an important factor. A fast reaction time at the start of a race enables a rider to place himself in a preferred position at during the initial portion of the race. Currently, there are no training devices that focus on the reaction time of a rider at the start of a race.

### BRIEF SUMMARY OF THE INVENTION

According to one aspect of the invention, a training device for motorcycle racing includes a handlebar including a right-hand grip and a left-hand grip, a control lever mounted to the handlebar at or near the left-hand grip for simulating a clutch of a motorcycle, and a timing circuit. The timing circuit may include a display, a timer, and an output such as a LED for generating a signal when activated. A random-timing generator may be connected to the timer and the output, and a switch may be connected to the timer and the random-timing generator and operatively connected to the control lever. In operation, the switch activates the random-timing generator when the control lever is actuated. In turn, the random-timing generator simultaneously activates the timer to begin timing and activates the output to generate a signal, at a random time after being activated by the switch. The switch then stops the timer when the control lever is released. The display displays an elapsed time between the time when the timer was activated and to the time when the timer was stopped.

Other features and advantages of the present invention will become apparent to those skilled in the art from a consideration of the following detailed description taken in conjunction with the accompanying drawings.

### BRIEF DESCRIPTION OF THE SEVERAL VIEWS OF THE DRAWINGS

FIG. 1 illustrates a training device for motorcycle racing;

FIG. 2 is a schematic view of a timing circuit of the training device;

FIG. 3 is a schematic view of an operative connection between a control lever and a switch of the timing circuit; and

FIG. 4 is a schematic view of a commercial embodiment of the timing circuit.

### DETAILED DESCRIPTION OF THE INVENTION

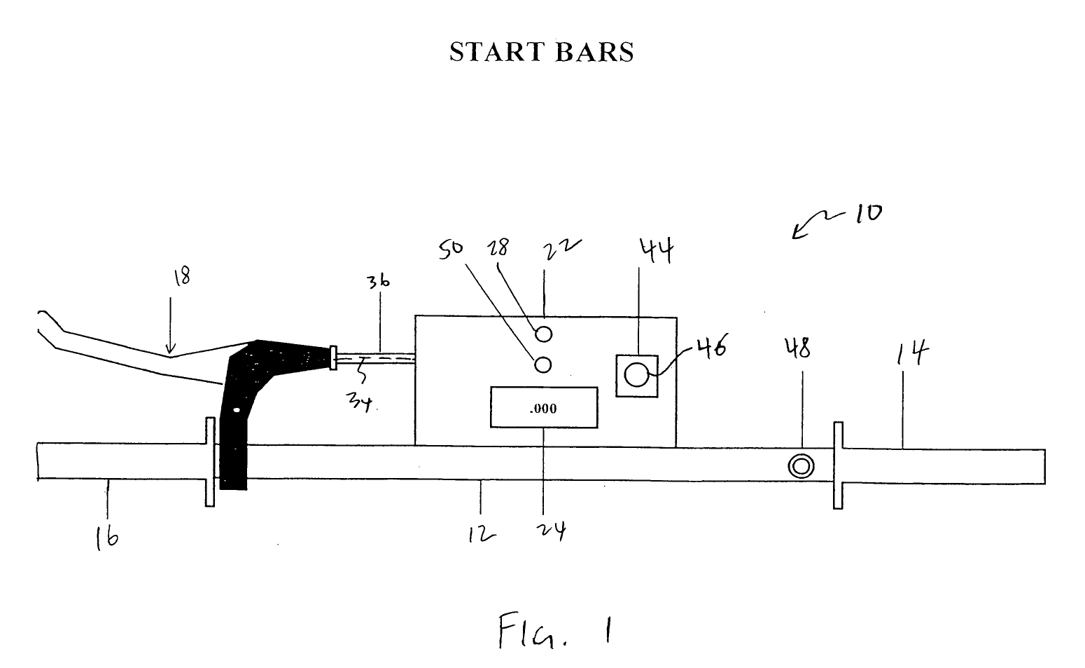

Referring more particularly to the drawings, a training device 10 for motorcycle racing is shown in FIG. 1. In a number of embodiments the training device 10 includes a handlebar 12 including a right-hand grip 14 and a left-hand grip 16. A control lever 18 is mounted to the handlebar 12 at or near the left-hand grip 16 for simulating a clutch of a motorcycle.

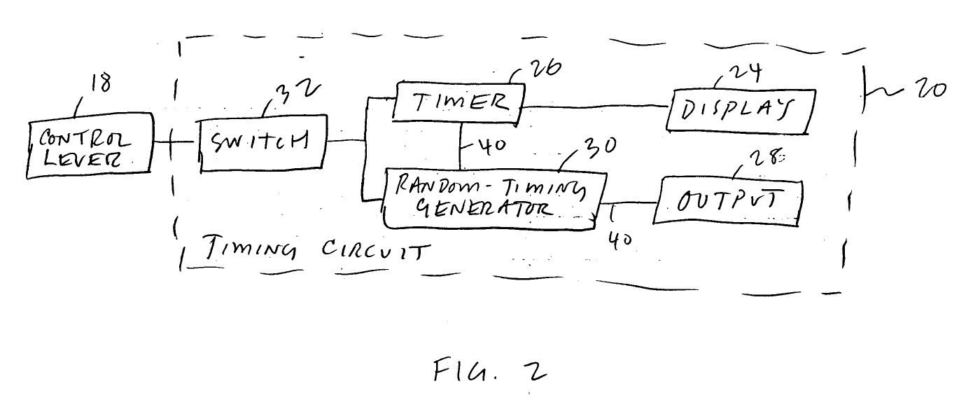

With reference to FIG. 2, the training device 10 also includes a timing circuit 20. The timing circuit 20 may be enclosed within a housing 22 mounted to the handlebar 12. In a number of embodiments the timing circuit includes a display 24, a timer 26 connected to the display 24, and an output 28 for generating a signal when activated, for example, an audio signal or a visual signal such as light. The timing circuit 20 also includes a random-timing generator 30 connected to the timer 26 and the output 28, and a switch 32 connected to the timer 26 and the random-timing generator 30.

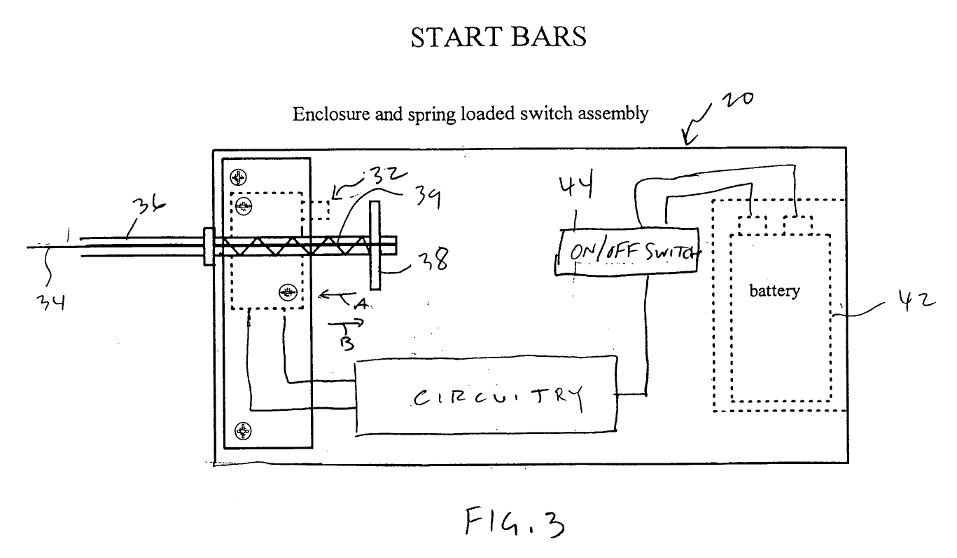

The switch 32 is also operatively connected to the control lever 18. For example, referencing FIGS. 1 and 3, a cable 34 within a sheath 36 may connect the control lever 18 to a plunger 38. Accordingly, when the control lever 18 is actuated (e.g., squeezed like a clutch), the plunger 38 moves inwardly (as shown by arrow A) to activate (e.g., close) the switch 32; and when the control lever 18 is released, the plunger 38 moves outwardly (as shown by arrow B) to deactivate (e.g., open) the switch 32. A spring 39 may be provided to bias the plunger 38 in an open position.

When the control lever 18 is actuated, the switch 32 activates the random-timing generator 30. When activated, the random-timing generator 32 generates a signal at a random time after activation, which signal is indicated by reference numeral 40 in FIG. 2. The signal 40 is provided to the timer 26 and the output 28 so that the timer 26 begins timing or counting and the output 28 generates a signal (e.g., lights up) simultaneously.

The user, upon becoming aware of the signal from the output 28, then releases the control lever 18, thereby opening the switch 32. When opened, the switch 32 stops the counting of the timer 26. The display 24 then displays the elapsed time between the time when the timer 26 (and the output 28) was activated and then time when the timer 26 was stopped. Accordingly, the training device 10 trains users to react to a random event analogous to the start of a motorcycle race.

Referencing FIGS. 1 and 3, the timing circuit 20 may include a power supply 42 such as a battery and an on/off switch 44 to control the power to the other circuitry. A power-on status light 46 may be provided to indicate the timing circuit 20 is ready to go.

In addition, the timing circuit 20 may include a reset switch 48. In a number of embodiments, the reset switch 48 may be mounted to the handlebar 12 at or near the right-hand grip 14 as shown in FIG. 1. The reset switch 48 may be actuated, for example, by depressing with the user's right thumb, to reset the display 24 to zero between random timing events.

Alternatively, the reset switch 48 may be used to initiate a random-timing event as described above. For example, a user may squeeze the control lever 18 and while holding the control lever 18 in a squeezed position, may actuate the reset switch 48, which may activate the random-timing generator 30 to generate the signal 40 at a random time in the future.

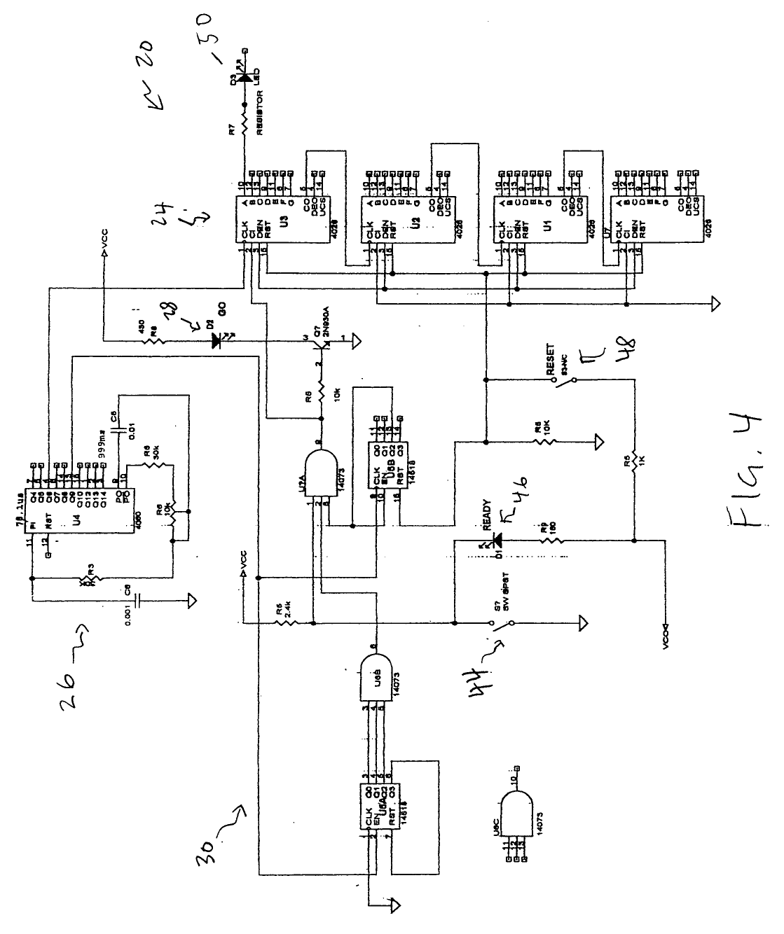

The timing circuit 20 may also include a status indicator 50 that is illuminated between the time the random-timing generator 30 is activated until the time the timer 26 and the output 28 are activated. The illuminated status indicator 50 informs the user that the circuit is in a random function and will provide the output at a random time. One specific commercial example of the timing circuit 20 is illustrated in FIG. 4.

In some of the embodiments, the training device 10 is self-contained and portable in that a user may hold the handlebars 12 at any position. Alternatively, the training device 10 may be mounted in a stationary position.

Those skilled in the art will understand that the preceding embodiments of the present invention provide the foundation for numerous alternatives and modifications thereto. For example, the signal output 28 may be a light, LED, or speaker (i.e., audio output) that provides a signal to a user. These other modifications are also within the scope of the present invention. Accordingly, the present invention is not limited to that precisely as shown and described in the present invention.

What is claimed is:

1. A training device for motorcycle racing, the device comprising:
a handlebar including a right-hand grip and a left-hand grip;
a control lever mounted to the handlebar at or near the left-hand grip for simulating a clutch of a motorcycle;
a timing circuit including:
a display;
a timer connected to the display;
an output for generating a signal when activated;
a random-timing generator connected to the timer and the output; and
a switch connected to the timer and the random-timing generator and operatively connected to the control lever;
the switch for activating the random-timing generator when the control lever is actuated;
the random-timing generator for simultaneously activating the timer to begin timing and activating the output to generate a signal, at a random time after being activated by the switch;
the switch for stopping the timer when the control lever is released; and
the display for displaying an elapsed time between the timer being activated and being stopped.

2. A device as claimed in claim 1 wherein the output is a visual output.

3. A device as claimed in claim 1 further comprising a power supply and an on/off switch for supplying power to the timing circuit.

4. A device as claimed in claim 1 wherein the switch is operatively connected to the control lever by a cable.

5. A device as claimed in claim 1 further comprising a reset switch for resetting the display to zero.
